(19) United States
(12) Patent Application Publication
(10) Pub. No.: US 2019/0225160 A1
(43) Pub. Date: Jul. 25, 2019

(54) Ignition Interlock Holster

(71) Applicant: Jon Russell Riggs, Prineville, OR (US)

(72) Inventor: Jon Russell Riggs, Prineville, OR (US)

(21) Appl. No.: 16/254,440

(22) Filed: Jan. 22, 2019

Related U.S. Application Data
(60) Provisional application No. 62/619,844, filed on Jan. 21, 2018.

(51) Int. Cl. B60R 7/06

(52) U.S. Cl. CPC B60R 7/06; B60K 28/063

(57) ABSTRACT

This present invention relates to devices and methods for holding an Ignition Interlock, and especially to devices and methods for securing an ignition Interlock inside a vehicle for a safer driving experience.

### RELATED APPLICATION

The present application is based upon and claims priority benefit of provisional application # 62/619,844, EFS ID # 31559581, entitled “Ignition Interlock Holster”, which was filed on Jan. 21, 2018, and is hereby incorporated by reference in its entirety.

### BACKGROUND

The requirement of Ignition Interlock systems being installed in vehicles after a DUI (driving under the influence of intoxicants) is vastly growing all over the world. Ignition Interlocks are proving to be effective in keeping people whom are intoxicated from using their vehicle, and also act as a great deterrent from people getting multiple DUI's. However, Ignition Interlocks inadvertently add several distractions and safety hazards to the driver, as well as to the other drivers on the road. For example, the majority of Ignition Interlock systems have a long cord connecting the Interlock device to the vehicle. This cord tends to be rather long and has a tendency to get tied up or caught up on things such as the gas and brake pedals, the emergency brake handle, or the stick shift in vehicles with a manual transmission. What is needed is a product that addresses these distractions, in order to make the safest driving conditions possible.

### SUMMARY

This present invention relates to devices and methods for holding an Ignition Interlock, and especially to devices and methods for securing an Ignition Interlock inside a vehicle for a safer driving experience. For example, an Ignition Interlock device generally has both a handheld device and a cord which, in themselves, are two of the distractions that this invention addresses by offering a housing unit to safely dock both the cord and the handheld device inside the vehicle, as opposed to the practices that are currently in play, such as simply lapping the device across the drivers leg or center console while the vehicle is in motion.

Because there are different styles of Ignition Interlocks, different configurations for different cars, and different needs for different people, we will include several possible configurations of the invention and their capabilities.

### BRIEF DESCRIPTION OF DRAWINGS

The following figures are included to better illustrate the embodiments of the devices and the techniques of the present invention. In these figures, like numerals represent like features in the several views. Tt is to be noted that in these figures, illustrating the several views of the present invention. unless stated to be otherwise, are not necessarily drawn to scale.

FIG. 1 shows by way of example a front view of one embodiment of an Ignition Interlock Holster.

FIG. 2 shows by way of example an inside view of one embodiment of an Ignition Interlock Holster.

FIG. 3 shows by way of example a top view of one embodiment of an Ignition Interlock Holster.

FIG. 4 shows by way of example a side facing view of one embodiment of an Ignition Interlock Holster.

FIG. 5 shows by way of example a front view of one embodiment of an Ignition Interlock Holster.

FIG. 6 shows by way of example a front facing view of one embodiment of an Ignition Interlock Holster.

FIG. 7 shows by way of example an angled front view of one embodiment of an Ignition Interlock Holster and also slightly shows the hook on the inside.

FIG. 8 shows by way of example one embodiment of a detachable hook that is used to secure the cord of the Ignition Interlock.

FIG. 9 shows by way of example a front facing view of one embodiment of an Ignition Interlock Holster mounted in a vehicle.

FIG. 10 shows by way of example a front facing view of one embodiment of an Ignition Interlock Holster mounted in a vehicle.

FIG. 11 shows by way of example a front facing view of one embodiment of an Ignition Interlock Holster and the detachable hook mounted in a vehicle.

FIG. 12 shows by way of example a front facing view of one embodiment of an Ignition Interlock Holster mounted in a vehicle.

FIG. 13 shows by way of example a side view of one embodiment of an Ignition Interlock Holster being used in one embodiment of its intended purpose.

### DETAILED DESCRIPTION OF THE PREFERRED EMBODIMENTS

It should, of course, be understood that the description and drawings herein are merely illustrative and that various modifications and changes can be made in the structures disclosed without departing from the scope of the appended claims. It will also be appreciated that the various identified components of the exemplary Ignition Interlock Holster device disclosed herein are merely terms of art that may vary from one manufacturer to another and should not be deemed to limit the present disclosure.

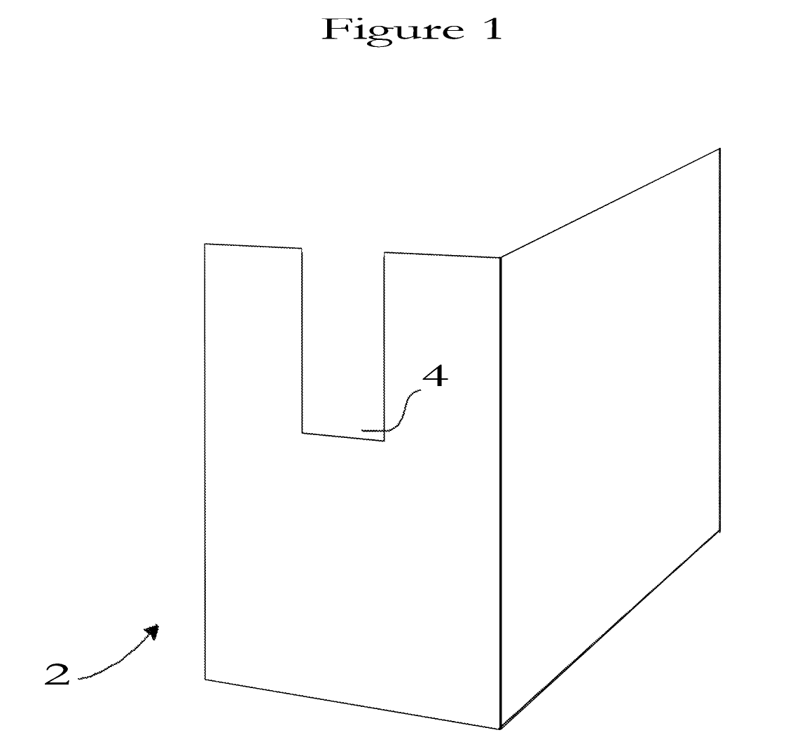

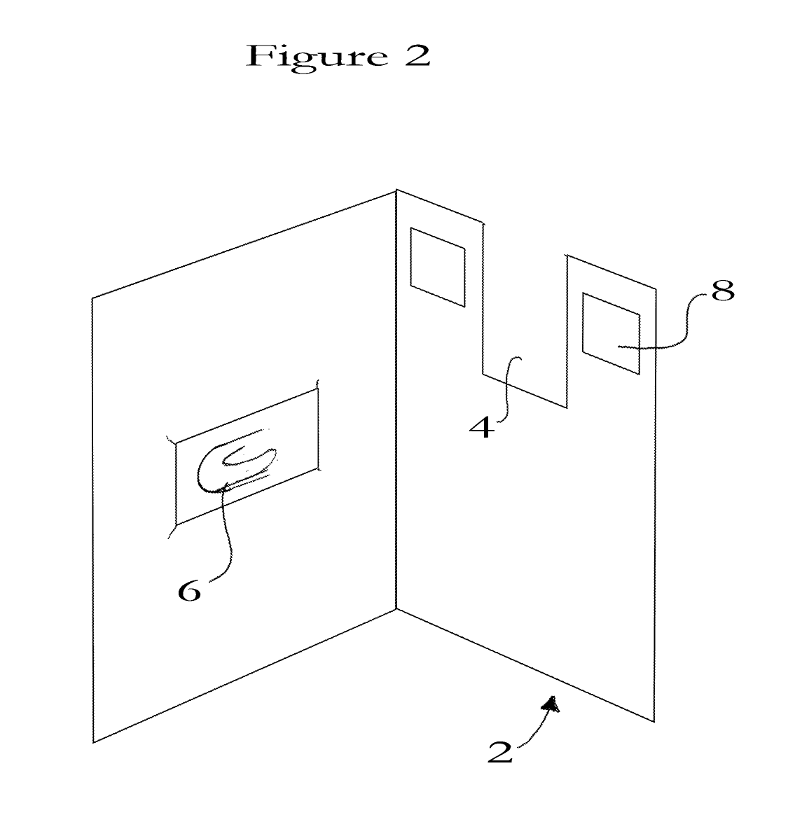

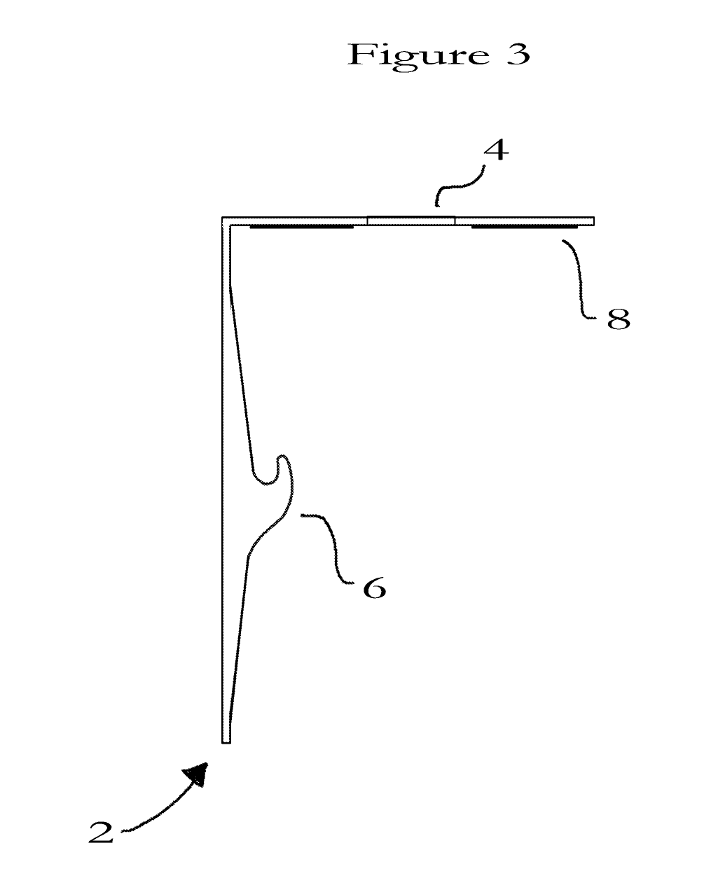

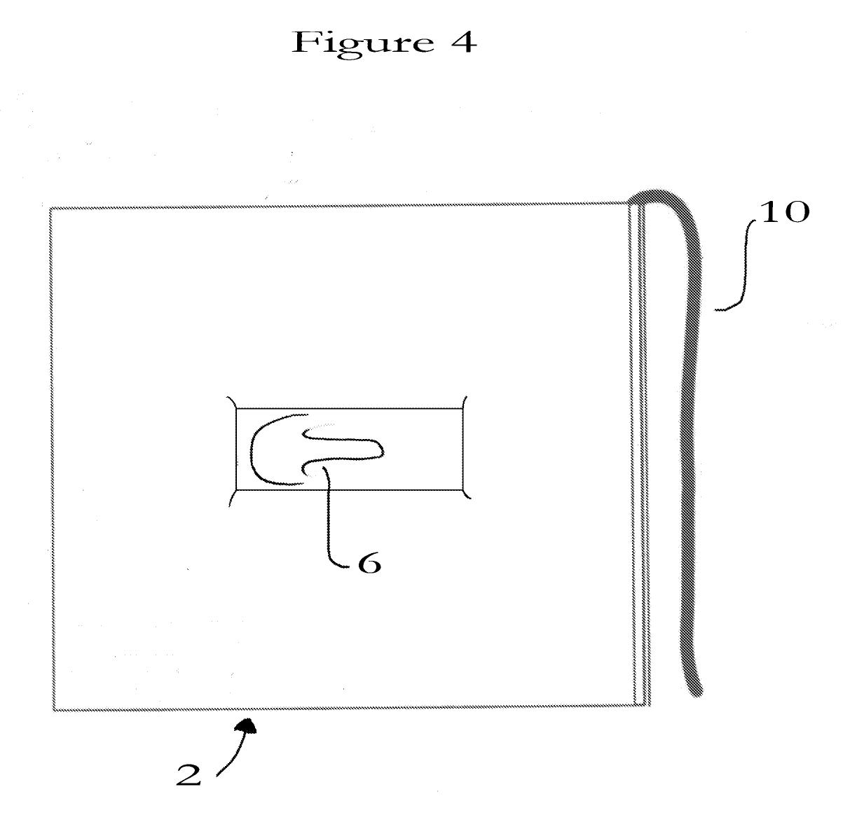

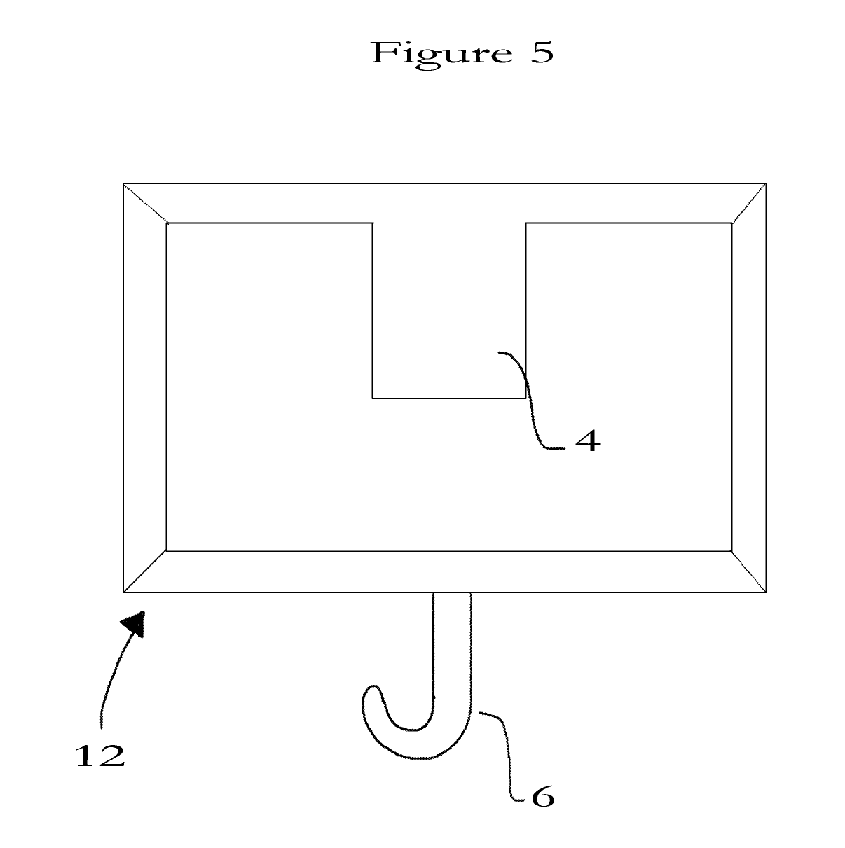

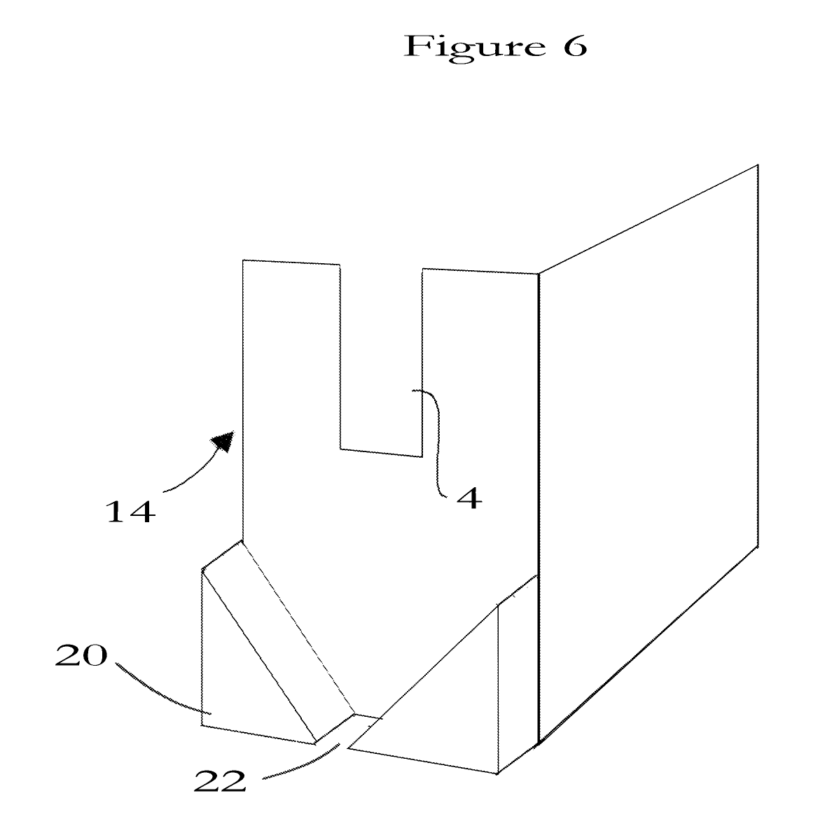

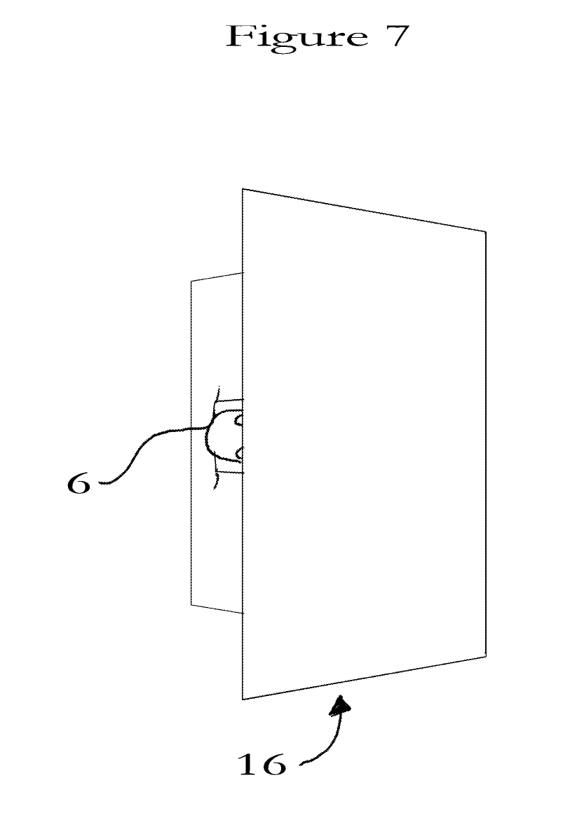

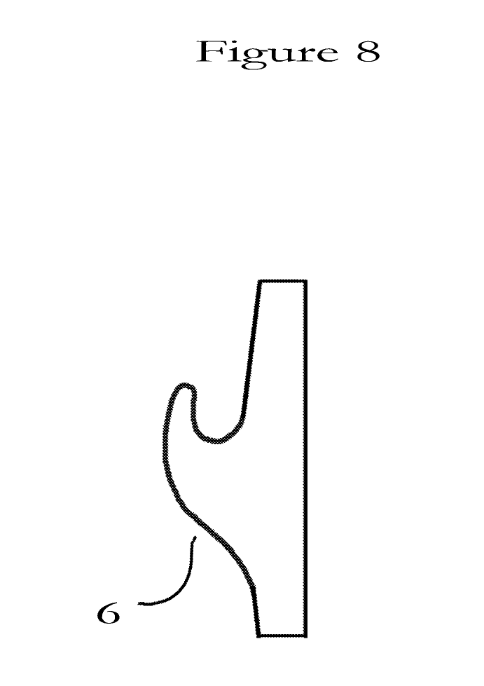

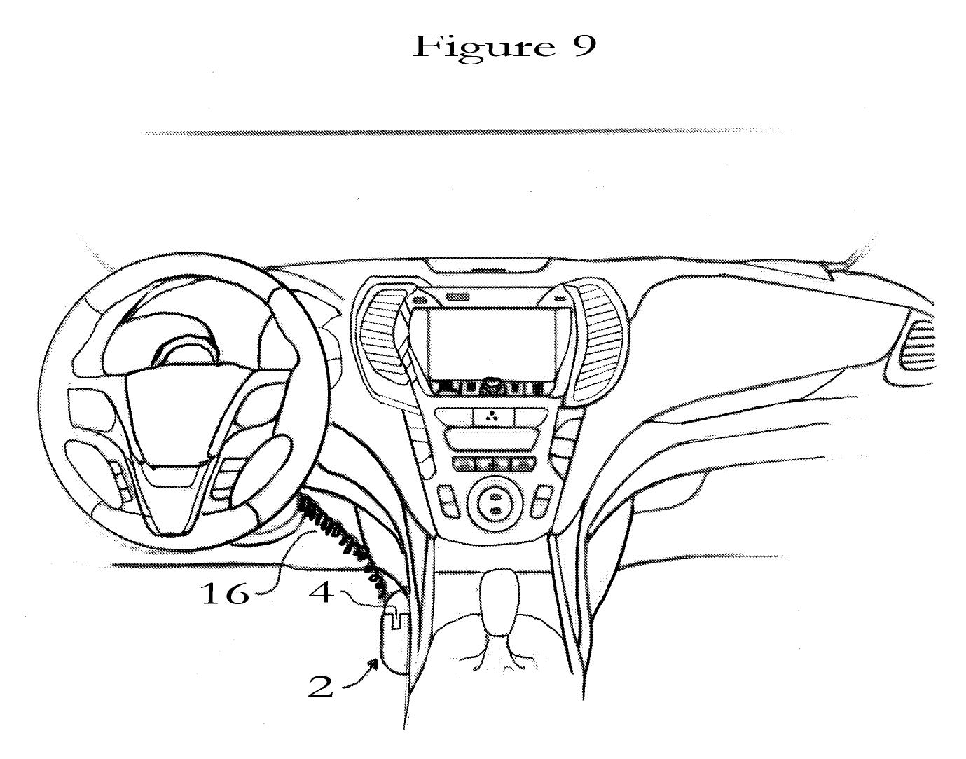

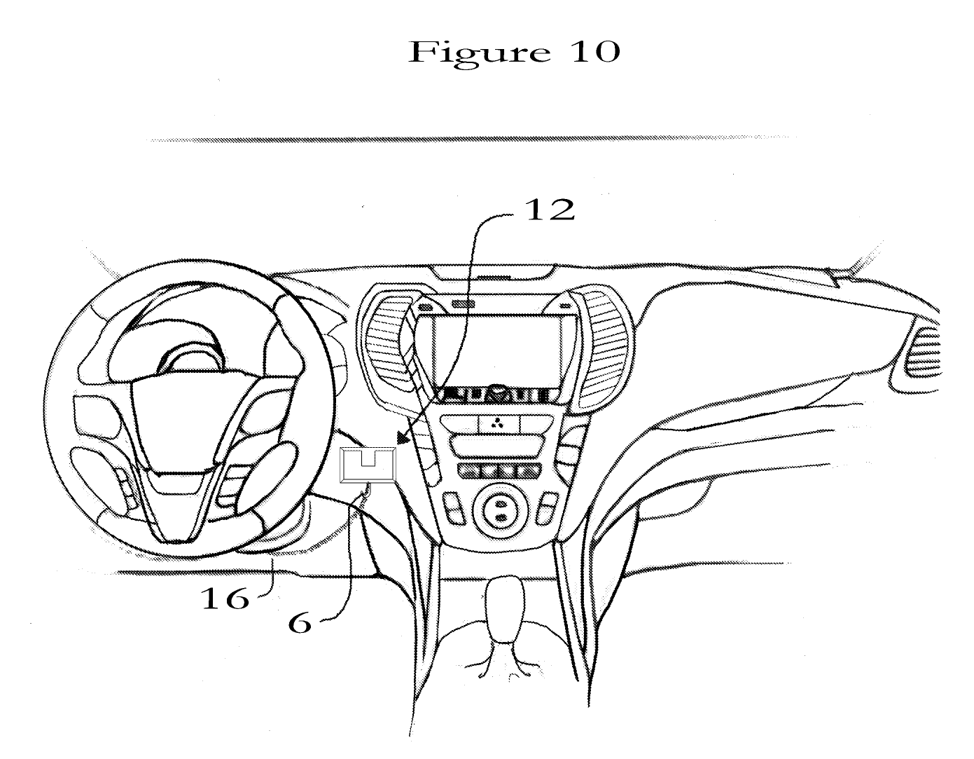

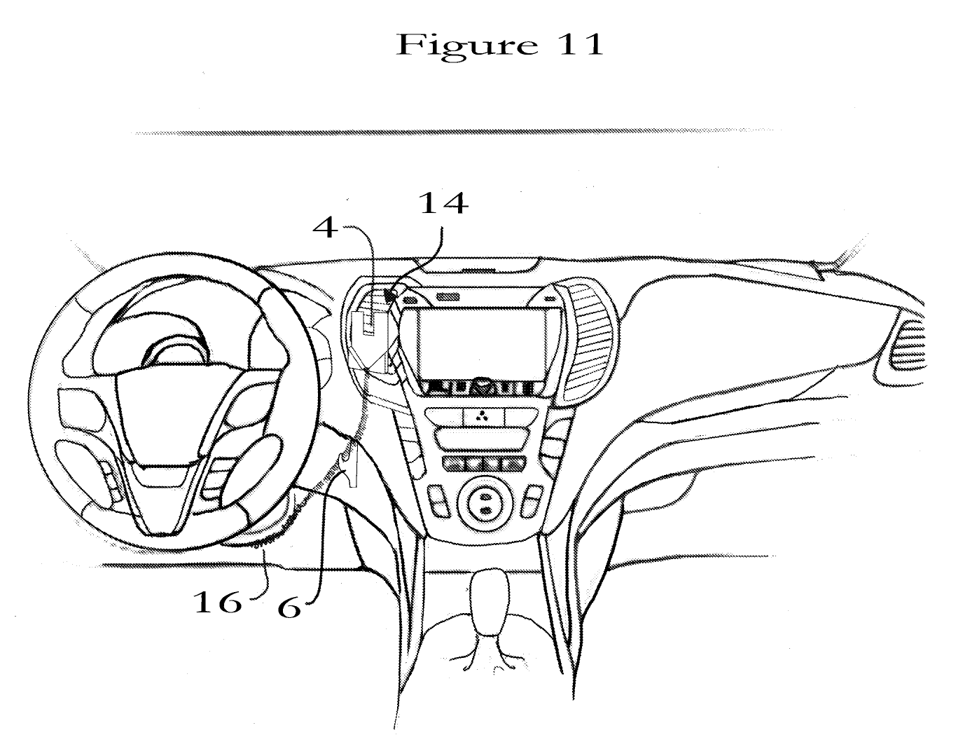

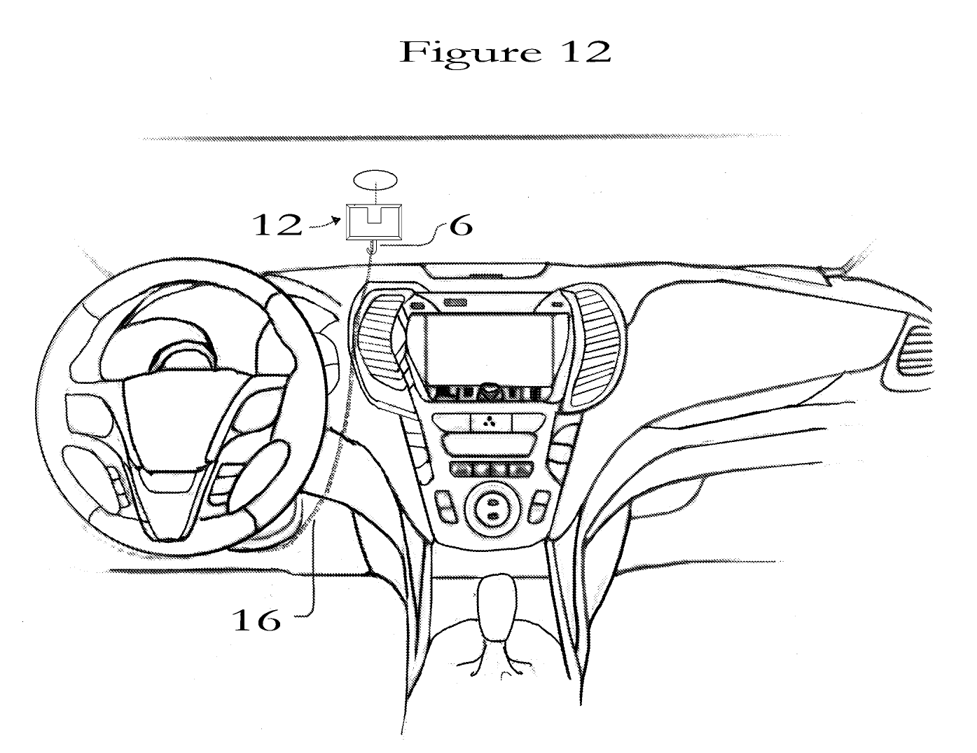

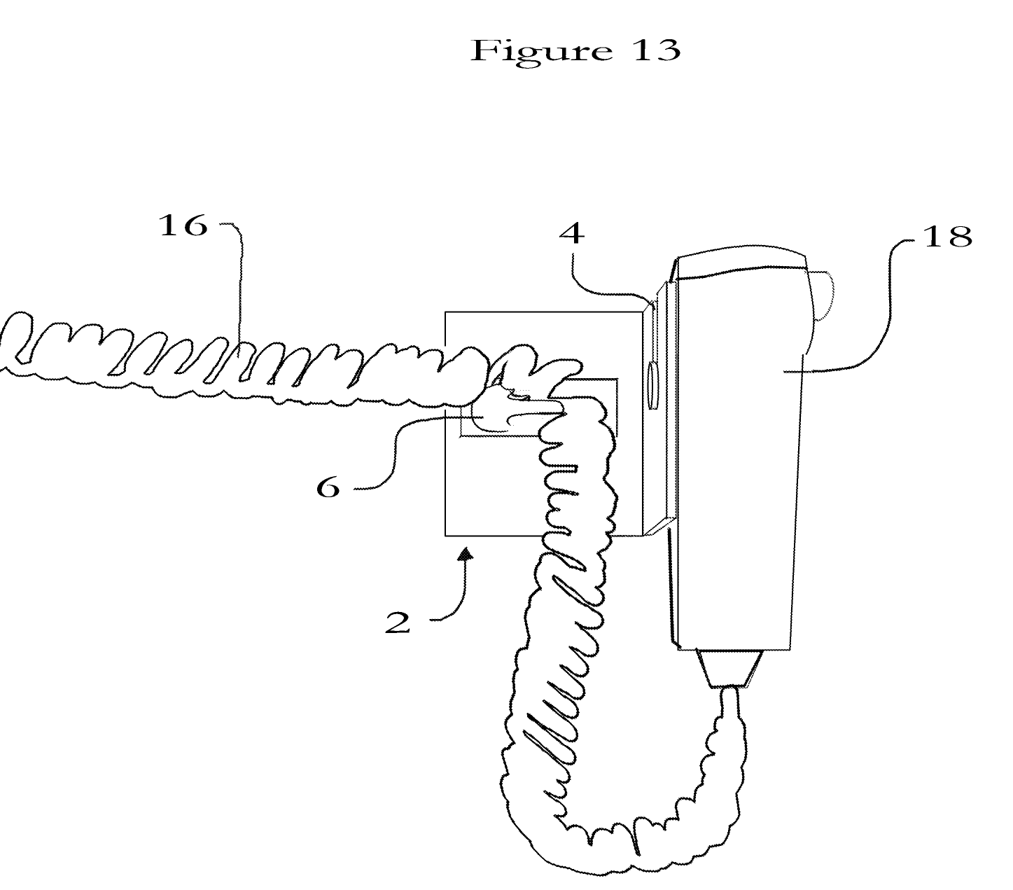

Referring now to the drawings, wherein like numerals refer to like parts throughout the several views, FIG. 1 shows by way of example one embodiment of an Ignition Interlock Holster 2, wherein there is a slot 4 that can be used to holster certain styles of Ignition Interlock devices. FIG. 2 shows by way of example an inside view of one embodiment of an Interlock Holster 2, wherein you can also see one embodiment of a hooking mechanism 6 which is meant to offer a way to secure the Interlock device cord which normally accompanies the Interlock device. This embodiment also shows possible mounting areas for an Ignition Interlock cover 8 which in this example would fold down over the top of the Interlock device, and a slot 4 to holster certain styles of Interlock devices. FIG. 3 shows by way of example a top down view of one embodiment of an Ignition Interlock Holster 2, a slot that can be used to holster an Interlock device 4, a hooking device 6, and possible mounting area for a cover 8. FIG. 4 shows by way of example a side view of one embodiment of an Ignition Interlock Holster 2, one embodiment of a booking device 6, and a possible Interlock device cover 10. FIG. 5 shows by way of example another possible embodiment of an Ignition Interlock Holster 12, with another embodiment of a possible hooking device 6, and a slot 4 for mounting certain styles of Interlock devices. FIG. 6 shows by way of example another possible embodiment of an Ignition Interlock Holster 14, which has an option to mount an Interlock device using a slot 4, or for other models of devices can simply be holstered by resting upon the added structures in the front 20, meanwhile still having an open area for the Interlock device cord to slide through if need be 22. FIG. 7 shows by way of example another possible embodiment of an Ignition Interlock Holster 16 wherein the holster offers a flush front where an adhesive can be used to mount certain styles of Interlock devices. This figures also shows the tail end of one embodiment of a hooking device 6. FIG. 8 shows by way of example a possible embodiment of a hooking device for an Ignition Interlock Holster 6, this hooking device can be made to be, but is not limited to be, detachable from or stationary to the holster, and comprises of a way to secure the Interlock devices cord. FIG. 9 shows by way of example one embodiment of an Ignition Interlock Holster 2, with a slot 4, holding up an Interlock device cord 16 inside of a vehicle (the cord 16 is in no way a part of this invention but is just being used to show the functionality of the holster). FIG. 10 shows by way of example another possible embodiment of an Ignition Interlock Holster 12, with one embodiment of a hooking method 6 securing an Interlock device cord 16, on the inside of a vehicle. FIG. 11 shows by way of example one possible embodiment of an Ignition Interlock Holster 14, with a slot 4, and the embodiment of a detachable hook 6 being used to secure an Interlock device cord 16 in unison with the Ignition Interlock Holster. 14. FIG. 12 shows by way of example one possible embodiment of an Ignition Interlock Holster 12, with a hooking device 6 securing a cord 16, inside a vehicle. FIG. 13 shows by way of example one embodiment of an Ignition Interlock Holster 2 being used to hold up an Ignition Interlock device 18 (the device 18 is only being used to show functionality of a holster and is in no way a part of this present invention), the cord 16 being held up by a hooking device 6, and the Interlock device 18 being attached to the Holster using a slot 4.

Having described the invention in detail and by reference to preferred embodiments thereof, it will be apparent that modifications and variations are possible without departing from the scope of the invention defined in the appended claims.

What is claimed is:

1. An Ignition Interlock Holster, comprising:
(a) A housing unit offering multiple locations and options to holster an Ignition Interlock device.
(b) An Ignition Interlock cord retainer associated with the housing unit.

2. A device according to claim 1 wherein the cord retainer comprises of an ability to detach from the housing unit.

3. A device according to claim 1 comprising of multiple options of attaching an Ignition Interlock device to the housing unit by way of, but not limited to, sticking, resting, hanging, etc.

4. A device according to claim 1 comprising of a housing unit and cord retainer used to secure an Ignition Interlock device and, if present, its cord inside a vehicle.

5. A device according to claim 1 comprising of a housing unit made to holster an Ignition Interlock device with the intention of using said unit inside a motor vehicle or vessel.

6. A device according to claim 1 comprising of a cord retainer either attached or detached from the housing unit with the purpose to retain an Ignition Interlock cord.
